(19) United States
(12) Patent Application Publication
(10) Pub. No.: US 2003/0126267 A1
(43) Pub. Date: Jul. 3, 2003

(54) Method and apparatus for preventing access to inappropriate content over a network based on audio or visual content

(75) Inventors: Srinivas Gutta, Yorktown Heights, NY (US); Serhan Dagtas, Croton on Hudson, NY (US); Tomas Brodsky, Croton on Hudson, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/029,921

(22) Filed: Dec. 27, 2001

(51) Int. Cl. G06F 15/16

(52) U.S. Cl. 709/229

(57) ABSTRACT

A method and apparatus are disclosed for restricting access to electronic media objects having objectionable content. The disclosed access control system prevents a user from accessing objectionable content based on an analysis of the audio or visual information associated with the content. For example, image processing techniques are employed to dynamically detect nudity, violence, or other identified inappropriate content in an image associated with an electronic media object. In addition, speech recognition techniques can be employed to dynamically detect one or more predefined stop words in audio information associated with an electronic media object. When a user first attempts to access an electronic media object, the audio or visual content (or both) of the electronic media object is analyzed to determine if the electronic media object contains any predefined inappropriate content. The inappropriate content may be defined, for example, in accordance with user-specific access privileges. The user is prevented from accessing the electronic media object if the content analysis determines that the electronic media object contains one or more predefined inappropriate content items, such as nudity, sexually explicit material, violent content or bad language.

### FIELD OF THE INVENTION

The present invention relates to methods and apparatus for filtering Internet and other content, and more particularly, to methods and apparatus for filtering content based on an analysis of audio or visual information associated with the content.

### BACKGROUND OF THE INVENTION

The Internet is a valuable resource that provides access to a wide variety of information. Some of the information available on the Internet, however, is not appropriate for all users. For example, while many web sites have content that may be educational or entertaining for children, there are a number of web sites that contain content that is not appropriate for children, such as sexually explicit or violent content. Thus, a number of Internet filtering products exist, such as Net Nanny™ and Cyber Patrol™, that may be configured by a parent or another adult to prevent children from accessing web sites having inappropriate content or to only allow access to designated sites having appropriate content. In addition, many of these products provide a tracking feature that tracks the Web sites, newsgroups and chat rooms that a child may visit, as well as the information that the child may send or receive.

Typically, Internet filtering products employ a static content rating database that indicates whether the content of a given web site is appropriate or objectionable. The content rating database is typically updated periodically. Thus, a child is permitted to access web sites having appropriate content and is prevented from accessing sites having objectionable content. While such content rating databases provide an effective basis for limiting access to inappropriate content, they suffer from a number of limitations, which if overcome, could further improve the ability to prevent a child from accessing inappropriate content.

First, the content rating databases typically consist of a finite list of web sites. Thus, many web sites, including new web sites, may not even be rated in the content rating database. As a result, a child may be prevented from accessing an unlisted web site that contains appropriate content. In addition, the content rating databases generally provide a content rating for an entire web site, and not individual pages on a web site. Thus, while a given web site may generally provide content that is appropriate for most children, one or more individual pages of the web site may have objectionable content. Thus, the Internet filtering product must decide whether to provide access to “all or nothing” of the web site's content.

A number of techniques have been proposed or suggested that can prevent access to individual web pages having objectionable content. For example, a number of dynamic Internet filtering products exist that can, for example, scan the text of a given web page and prevent access if one or more predefined stop words are identified. However, such dynamic Internet filtering products are unable to identify non-textual content that is not appropriate for children, such as sexually explicit or violent images. A need therefore exists for an improved method and apparatus for preventing access to objectionable content. A further need exists for a method and apparatus for preventing access to objectionable content based on an analysis of the audio or visual information associated with the content.

### SUMMARY OF THE INVENTION

Generally, a method and apparatus are disclosed for restricting access to electronic media objects having objectionable content. The electronic media objects may be downloaded over a network or generated in real-time, for example, by a video camera. According to one feature of the invention, the disclosed access control system prevents a user from accessing objectionable content based on an analysis of the audio or visual information associated with the content. For example, image processing techniques are employed to dynamically detect nudity, violence, or other identified inappropriate content in an image associated with an electronic media object. In addition, speech recognition techniques can be employed to dynamically detect one or more predefined stop words in audio information associated with an electronic media object.

When a user first attempts to access an electronic media object, the audio or visual content (or both) of the electronic media object is analyzed to determine if the electronic media object contains any predefined inappropriate content. The inappropriate content may be defined, for example, in accordance with user-specific access privileges. The user is prevented from accessing the electronic media object if the content analysis determines that the electronic media object contains one or more predefined inappropriate content items, such as nudity, sexually explicit material, violent content or bad language.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a content-based access control system in accordance with the present invention;

FIG. 2 is a sample table from an exemplary user profile of FIG. 1;

FIG. 3 is a sample table from an exemplary stop word database of FIG. 1; and

FIG. 4 is a flow chart describing an exemplary audio/visual content evaluation process of FIG. 1 embodying principles of the present invention.

### DETAILED DESCRIPTION

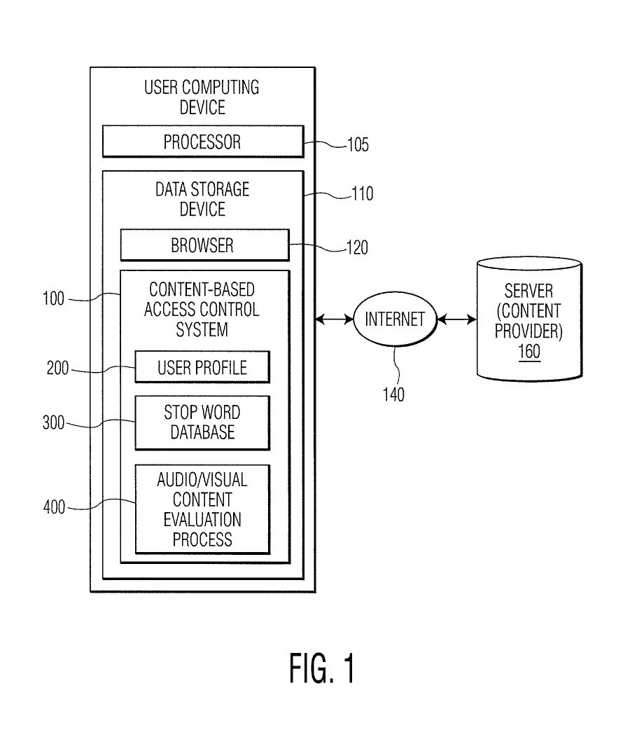

FIG. 1 illustrates a content-based access control system 100 in accordance with the present invention. In the exemplary embodiment, the content-based access control system 100 cooperates with a Web browser 120 to obtain an electronic media object from a server 160 over the Internet or World Wide Web (“Web”) environment 140. The browser 120 may use the hypertext transfer protocol (HTTP) or a similar Internet protocol to communicate with the server 160 to access electronic media objects. The content-based access control system 100 of the present invention may be independent of the browser 120, as shown in FIG. 1, or may be integrated with the browser 120, as would be apparent to a person of ordinary skill in the art. Furthermore, the content-based access control system 100 may execute on the user's machine, as shown in FIG. 1, or may be placed on an alternate machine, such as a central web proxy or a server, such as the server 160. As used herein, an electronic media object is any entity electronic media object that can be obtained from a local or remote source, such as the Internet, including HTML documents, images, audio and video streams and applets. In a further variation, the electronic media objects that are filtered by the present invention may be generated in real-time, for example, by a video camera or another recording device.

According to one aspect of the present invention, the content-based access control system 100 prevents access to objectionable content based on an analysis of the audio or visual information associated with the content. In one variation, image processing techniques are employed to dynamically detect nudity, violence, or other inappropriate content in an electronic media object. In another variation, speech recognition techniques are employed to dynamically detect one or more predefined stop words in an electronic media object. In yet another variation, face recognition techniques are employed to identify one or more actors who are known to appear in adult films. Alternatively, the present invention assumes that actors who appear in regular programming generally do not appear in adult films. Thus, face recognition techniques can be employed to prevent access to an electronic media object containing one or more actors who are not listed on a predefined list of actors who are known to appear in regular programming.

The content-based access control system 100 may be embodied as any computing device, such as a personal computer or workstation, that contains a processor 105, such as a central processing unit (CPU), and data storage device or memory 110, such as RAM and/or ROM. The content-based access control system 100 may also be embodied as an application specific integrated circuit (ASIC), for example, in a set-top terminal or display (not shown). The browser 120 may be embodied as any commercially available browser, such as Netscape Communicator™ or Microsoft Internet Explorer™, as modified herein to incorporate the features and functions of the present invention.

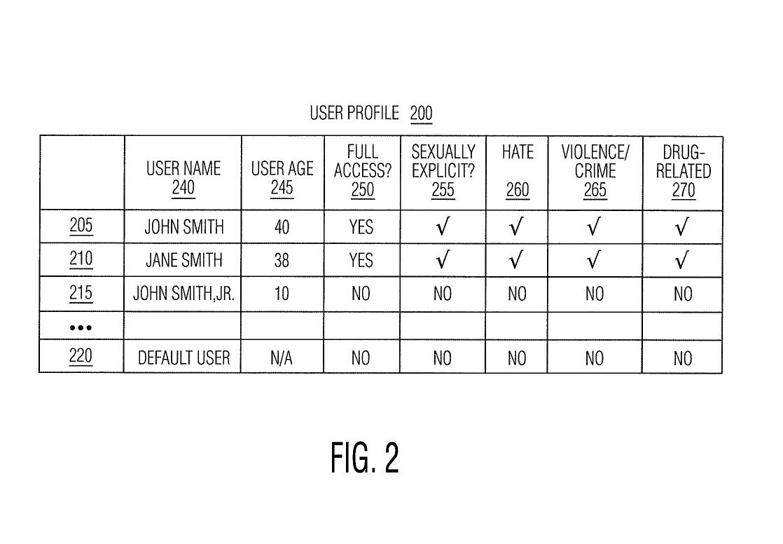

As shown in FIG. 1, and discussed further below in conjunction with FIGS. 2 through 4, the content-based access control system 100 includes a user profile 200, a stop word database 300 and an audio/visual content evaluation process 400. Generally, the user profile 200 indicates the Internet privileges of each user. In one exemplary embodiment, the user profile 200 indicates whether each user can access certain categories of content. The stop word database 300 contains a listing of one or more predefined stop words that should prevent a user from accessing any electronic media containing such stop words. Finally, the audio/visual content evaluation process 400 analyzes the audio or visual content associated with a given electronic media object to prevent certain users from accessing objectionable content.

FIG. 2 is a table illustrating an exemplary user profile 200. As previously indicated, the user profile 200 contains the Internet privileges of each user, such as an indication of whether each user can access certain categories of content. As shown in FIG. 2, the exemplary user profile 200 contains a plurality of records 205-220 each associated with a different user. For each user identified in column 240, the user profile 200 indicates the user's age in column 245 and whether the user has full access to all types of Internet content in field 250. In addition, the user can be provided with selective access to various categories of Internet content in accordance with the configuration settings entered in fields 255-270. For example, if a given user is not permitted to access sexually explicit content, an appropriate indication would be entered in field 255.

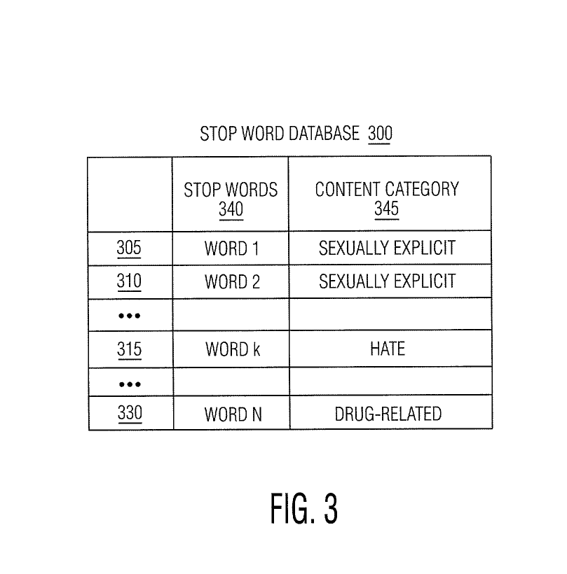

FIG. 3 is a table illustrating an exemplary stop word database 300. As previously indicated, the stop word database 300 contains a listing of one or more predefined stop words that should prevent a user from accessing any electronic media containing such stop words. As shown in FIG. 3, the exemplary stop word database 300 contains a plurality of records 305-330 each associated with a different stop word. For each stop word identified in column 340, the stop word database 300 indicates the corresponding content category to which the stop word belongs in field 345. Thus, if a given user is not permitted to access sexually explicit content (as indicated in field 255 of the user profile 200), the user is prevented from accessing any content containing the corresponding sexually explicit stop words indicated in the stop word database 300.

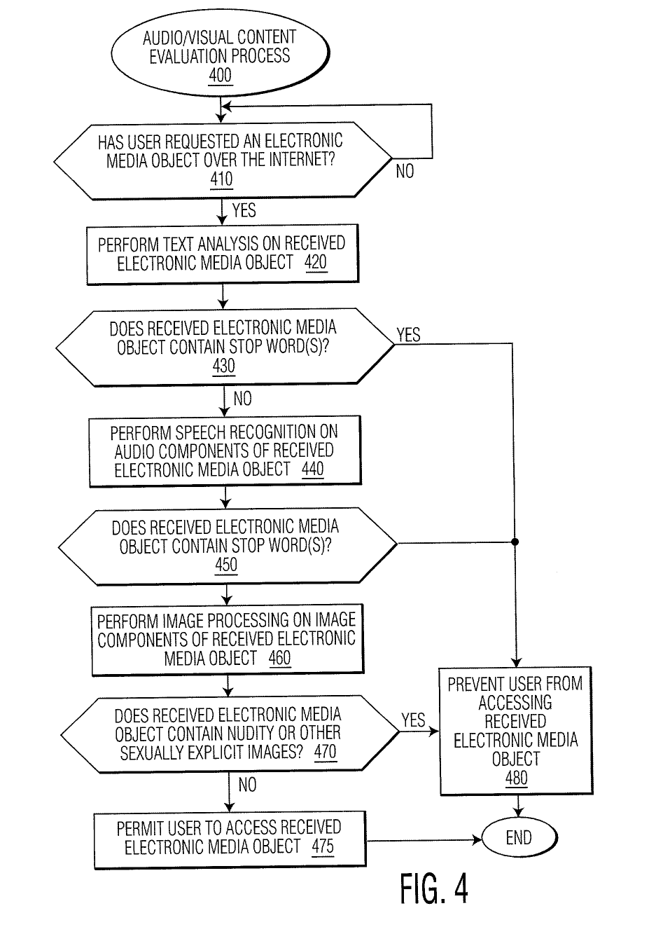

FIG. 4 is a flow chart describing an exemplary audio/visual content evaluation process 400 embodying principles of the present invention. As previously indicated, the audio/visual content evaluation process 400 analyzes the audio or visual content associated with a given electronic media object to prevent certain users from accessing objectionable content.

As shown in FIG. 4, the program recommendation process 400 initially performs a test during step 410 until it is determined that the user has requested an electronic media object over the Internet. Once it is determined during step 410 that the user has requested an electronic media object over the Internet, then program control proceeds to step 420, where a textual analysis is performed on the received electronic media object to compare the text of the media object to the stop words in the stop word database 300.

A further test is performed during step 430 to determine if the received electronic media object contains one or more predefined stop words based on the textual analysis. If it is determined during step 430 that the received electronic media object contains one or more predefined stop words, then program control proceeds to step 480, discussed below. If, however, it is determined during step 430 that the received electronic media object does not contain one or more of the predefined stop words, then speech recognition is performed on the audio components of the electronic media object during step 440.

A test is performed during step 450 to determine if the received electronic media object contains one or more stop words based on the speech recognition analysis. If it is determined during step 450 that the received electronic media object contains one or more stop words based on the speech recognition analysis, then program control proceeds to step 480, discussed below. If, however, it is determined during step 450 that the received electronic media object does not contain one or more of the predefined stop words, then image processing is performed on the image portions of the electronic media object during step 460.

A test is performed during step 470 to determine if the received electronic media object contains nudity or other sexually explicit images or other inappropriate imagery. Nudity may be identified, for example, by searching for human skin in accordance with various techniques, such as the techniques described in Forsyth and Fleck, “Identifying Nude Pictures,” Proc. of the Third IEEE Workshop, Appl. of Computer Vision, 103-108, Dec. 2-4, 1996, the disclosure of which is incorporated by reference herein. In a further variation, nudity may be identified, for example, if a distribution of skin pixels in an image exceeds a predefined threshold, such as at least 80 percent (80%) of the image.

Sexually explicit images can be identified, for example, by training a classifier. In one variation, features are extracted from a sample set of images related to sexually explicit content and the classifier is then trained using these features. The two classes of interest are images containing sexually explicit content and images without sexually explicit content. For a more detailed discussion of suitable classifiers, such as Bayesian classifiers or a decision tree (DT) classifiers, see, for example, U.S. patent application Ser. No. _____, filed ______, entitled “CLASSIFIERS USING EIGEN NETWORKS FOR RECOGNITION AND CLASSIFICATION OF OBJECTS,” (Attorney Docket No. US010566), assigned to the assignee of the present invention and incorporated by reference herein. The analyzed features can include gradient based information, such as those described in U.S. patent application Ser. No. 09/794,443, filed Feb. 27, 2001, entitled “Classification of Objects Through Model Ensembles,” incorporated by reference herein, or color information.

Violence may be identified in an electronic media object, for example, by analyzing facial expressions or by observing rapid change transitions since there are typically a lot of changes in content from one frame to another in violent images. Facial expressions can be analyzed using known facial expression analysis techniques, such as those described in “Facial Analysis from Continuous Video with Application to Human-Computer Interface,” Ph.D. Dissertation, University of Illinois at Urbana-Champaign (1999); or Antonio Colmenarez et al., “A Probabilistic Framework for Embedded Face and Facial Expression Recognition,” Proc. of the Int'l Conf. on Computer Vision and Pattern Recognition,” Vol. I, 592-97, Fort Collins, Colo. (1999), each incorporated by reference herein. The intensity of the facial expression may be obtained, for example, in accordance with the techniques described in U.S. patent application Ser. No. 09/705,666, filed Nov. 3, 2000, entitled “Estimation of Facial Expression Intensity Using a Bi-Directional Star Topology Hidden Markov Model,” assigned to the assignee of the present invention and incorporated by reference herein. It is noted that the following facial expressions are typically associated with violent content anger, fear, disgust, sadness and surprise. In a further variation, the intensity of the expression can be evaluated to identify electronic media objects containing violent content.

If it is determined during step 470 that the received electronic media object does not contain nudity or other sexually explicit images, then the electronic media object can be presented to the user during step 475 before program control terminates. If, however, it is determined during step 470 that the received electronic media object contains nudity or other sexually explicit images, then program control proceeds to step 480. In a further variation, a number of the conditions in steps 430, 450 and 470 can be aggregated to prevent access to an electronic media object, e.g., if a certain threshold of stop words and nudity are present in an electronic media object.

If it is determined during steps 430, 450 or 470 that the received electronic media object contains inappropriate content for this user, then the user is prevented from accessing the received electronic media object during step 480. Alternatively, the inappropriate content may be removed from the electronic media object during step 480 before presenting the electronic media object to the user. For example, stop words can be deleted from the text or audio, or sexually explicit images can be blurred in an image. In addition, the audio/visual content evaluation process 400 can also prevent the electronic media object from being stored during step 480 as well. Sexually explicit images can be blurred in an image in accordance with the teaching of U.S. patent application Ser. No. ______, filed ______, entitled “Method and Apparatus for Automatic Face Blurring,” (Attorney Docket Number US010558), incorporated by reference herein.

It is to be understood that the embodiments and variations shown and described herein are merely illustrative of the principles of this invention and that various modifications may be implemented by those skilled in the art without departing from the scope and spirit of the invention.

What is claimed is:

1. A method for preventing access to an electronic media object, comprising:
analyzing at least one of audio and image information associated with said electronic media object; and
preventing a user from accessing said electronic media object if said analyzing step determines that said electronic media object contains one or more predefined inappropriate content items.

2. The method of claim 1, further comprising the step of storing a user profile indicating the Internet browsing privileges of a user.

3. The method of claim 2, wherein said user profile indicates categories of content that a user may access.

4. The method of claim 2, further comprising the step of comparing said electronic media object to said Internet browsing privileges of a user.

5. The method of claim 1, further comprising the step of performing speech recognition on said electronic media object to determine if said electronic media object includes one or more predefined stop words.

6. The method of claim 1, further comprising the step of performing image processing on said electronic media object to determine if said electronic media object includes nudity.

7. The method of claim 6, wherein said nudity is determined by identifying human skin.

8. The method of claim 1, further comprising the step of performing image processing on said electronic media object to determine if said electronic media object includes sexually explicit images.

9. The method of claim 1, further comprising the step of performing image processing on said electronic media object to determine if said electronic media object includes violent images.

10. The method of claim 1, wherein said electronic media object is obtained from a network connection.

11. The method of claim 1, wherein said electronic media object is generated in real-time by a camera.

12. A system for preventing access to an electronic media object, comprising:
a memory for storing computer readable code; and
a processor operatively coupled to said memory (110), said processor configured to:
analyze at least one of audio and image information associated with said electronic media object; and
prevent a user from accessing said electronic media object if said analyzing step determines that said electronic media object contains one or more predefined inappropriate content items.

13. The system of claim 12, wherein said processor is further configured to store a user profile indicating the Internet browsing privileges of a user.

14. The system of claim 13, wherein said user profile indicates categories of content that a user may access.

15. The system of claim 13, wherein said processor is further configured to compare said electronic media object to said Internet browsing privileges of a user.

16. The system of claim 12, wherein said processor is further configured to perform speech recognition on said electronic media object to determine if said electronic media object includes one or more predefined stop words.

17. The system of claim 12, wherein said processor is further configured to perform image processing on said electronic media object to determine if said electronic media object includes nudity.

18. The system of claim 17, wherein said nudity is determined by identifying human skin.

19. The system of claim 12, wherein said processor is further configured to perform image processing on said electronic media object to determine if said electronic media object includes sexually explicit images.

20. The system of claim 12, wherein said processor is further configured to perform image processing on said electronic media object to determine if said electronic media object includes violent images.

21. The system of claim 12, wherein said electronic media object is obtained from a network connection.

22. The system of claim 12, wherein said electronic media object is generated in real-time by a camera.

23. An article of manufacture for preventing access to an electronic media object, comprising:
a computer readable medium having computer readable code means embodied thereon, said computer readable program code means comprising:
a step to analyze at least one of audio and image information associated with said electronic media object; and
a step to prevent a user from accessing said electronic media object if said analyzing step determines that said electronic media object contains one or more predefined inappropriate content items.

24. A system for preventing access to an electronic media object, comprising:
means for analyzing at least one of audio and image information associated with said electronic media object; and
means for preventing a user from accessing said electronic media object if said analyzing step determines that said electronic media object contains one or more predefined inappropriate content items.
